(19) United States
(12) Patent Application Publication
(10) Pub. No.: US 2012/0092825 A1
(43) Pub. Date: Apr. 19, 2012

(54) ELECTRONIC DEVICE WITH HEAT DISSIPATION MODULE

(75) Inventor: GUO-HE HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/092,004

(22) Filed: Apr. 21, 2011

(30) Foreign Application Priority Data
Oct. 15, 2010 (CN) 201010509999.4

(51) Int. Cl. G06F 1/20

(52) U.S. Cl. 361/679.52

(57) ABSTRACT

An electronic device includes a mainframe module and a heat dissipation module. The mainframe module includes a base panel and a motherboard attached on the base panel. The motherboard has a first heat generating component and a second heat generating component mounted thereon. The heat dissipation module includes a first heat sink, a second heat sink attached to a first open side of the first heat sink, a first heat pipe, and a second heat pipe. The first heat pipe is connected between the first heat sink and the first heat generating component. The second heat pipe is connected between the second heat sink and the second heat generating component. The motherboard and the heat dissipation module are mounted on the base panel side by side.

### BACKGROUND

1. Technical Field

The present disclosure relates to electronic devices, and more particularly to an electronic device with a heat dissipation module installed therein.

2. Description of Related Art

Many electronic devices (e.g., portable computers, all-in-one computers, etc.) include a circuit board and a heat dissipation module. The heat dissipation module includes a heat sink attached on a heat generating component of the circuit board and a fan mounted on the heat sink. The heat sink and the fan can dissipate heat from the heat generating component to keep a temperature of the heat generating component within a safe operating range. However, the heat sink and the fan take up much space above the circuit board, which adds to the size of the electronic device.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an electronic device according to a first embodiment.

FIG. 2 is an assembled view of the electronic device of FIG. 1.

FIG. 3 is an exploded view of an electronic device according to a second embodiment.

FIG. 4 is an assembled view of the electronic device of FIG. 3.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

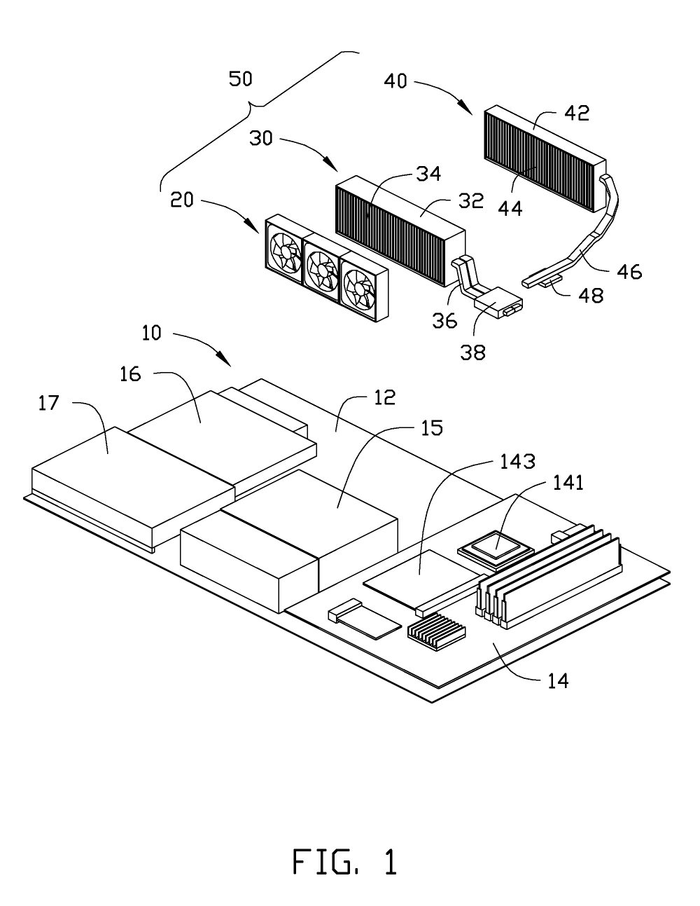

Referring to FIG. 1, a first embodiment of an electronic device includes a main frame module 10 and a heat dissipation module 50. The electronic device can be an all-in-one computer, a notebook computer etc.

The mainframe module 10 includes a base panel 12 and a motherboard 14 attached on the base panel 12. A first heat generating component 141 and a second heat generating component 143 are attached on the motherboard 14. A power supply module 15, an optical disk drive 16, and a hard disk drive 17 are attached on the base panel 12. In one embodiment, the first heat generating component 141 is a central processing unit mounted on the motherboard 14. The second heat generating component 143 is a video card that is removable along a direction parallel to the motherboard 14.

The heat dissipation module 50 includes a plurality of fans 20, a first heat sink 30, and a second heat sink 40. The first heat sink 30 includes a first outer shell 32, a plurality of parallel first fins 34 enclosed by the first outer shell 32, and a pair of first heat pipes 36. A first end of the pair of first heat pipes 36 extends through the plurality of first fins 34. A first connecting block 38 is attached to a second end of the pair of first heat pipes 36.

The second heat sink 40 includes a second outer shell 42, a plurality of parallel second fins 44, and a second heat dissipation pipe 46. One end of the second heat dissipation pipe 46 extends through the plurality of second fins 44. A second connecting block 48 is attached to a second end of the second heat dissipation pipe 46.

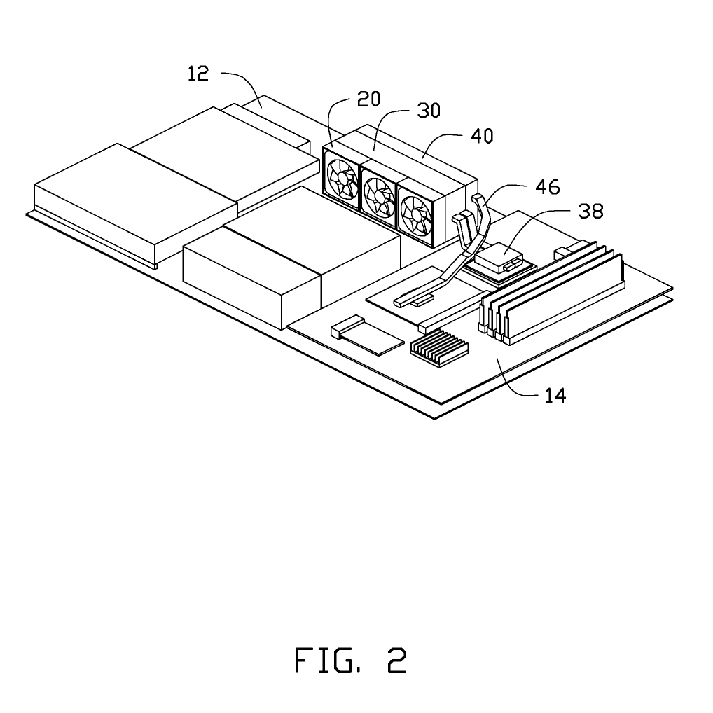

Referring to FIG. 2, in assembly, the first heat sink 30 is attached to the plurality of fans 20. The second heat sink 40 is attached to the first heat sink 30. The first heat sink 30 is sandwiched between the plurality of fans 20 and the second heat sink 40. Then the heat dissipation module 50 is assembled and attached on the base panel 12 at a position adjacent to the motherboard 14. The heat dissipation module 50 and the motherboard 14 are attached on the base panel side by side. The first connecting block 38 is attached on the first heat generating component 141. The second connecting block 48 is attached on the second heat generating component 143. The pair of first heat pipes 36 can take away heat from the first heat generating component 141. The second heat pipe 46 can take away heat from the second heat generating component 143. The plurality of fans 20 can generate airflow that flows to the first heat sink 30 and the second heat sink 40, thereby dissipating heat for the pair of first heat pipes 36 and the second heat pipe 46. In one embodiment, the second heat sink 40 can be removed if there is not a video card attached on the motherboard 14. Some motherboards have video chips mounted thereon and do not need video cards.

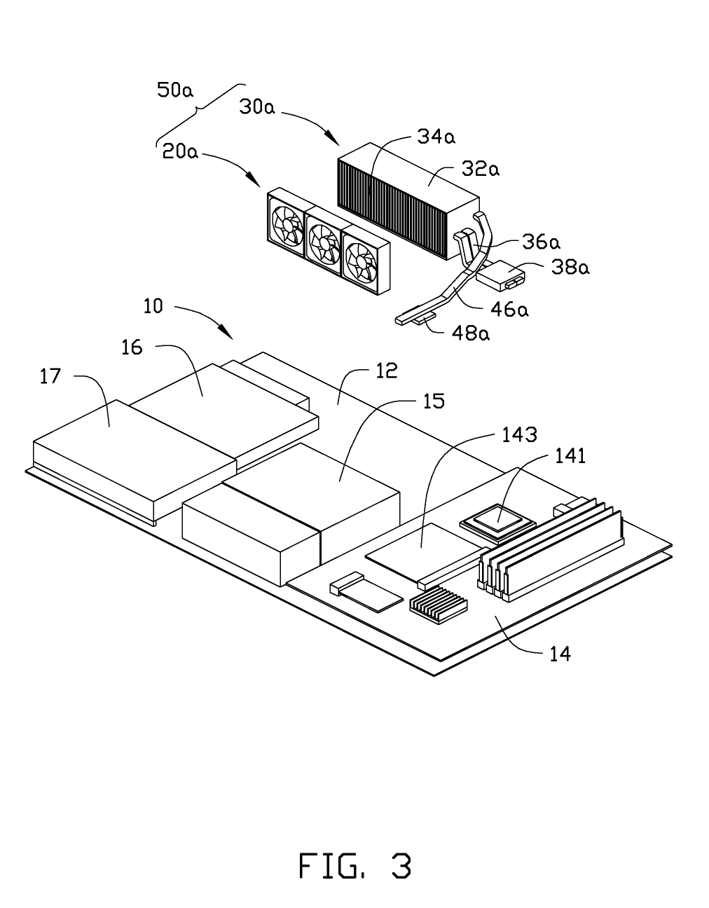

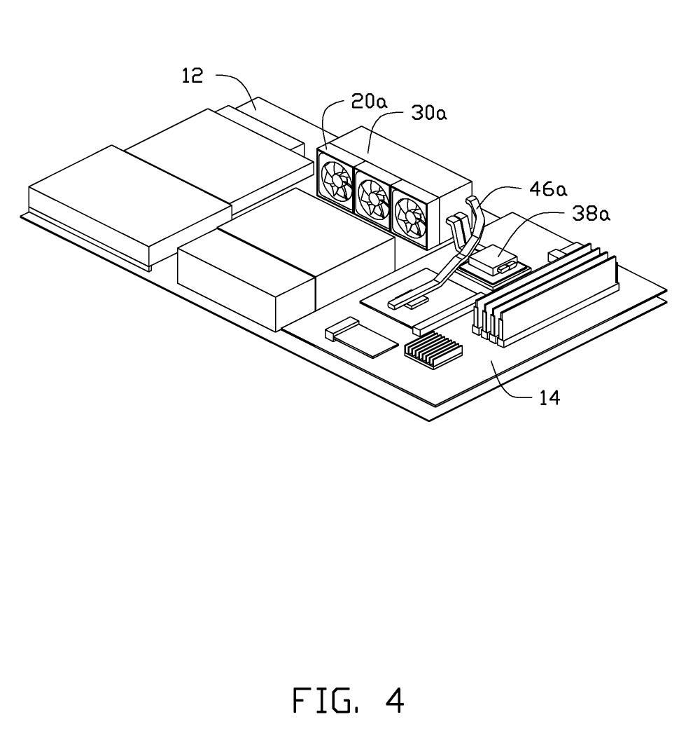

In one embodiment shown in FIGS. 3 and 4, the electronic device includes a second heat dissipation module 50a. The second heat dissipation module 50a includes a plurality of cooling fans 20a and a third heat sink 30a. The third heat sink 30a includes a third outer shell 32a, a plurality of third fins 34a, a pair of third heat pipes 36a, and a fourth heat pipe 46a. A first end of the pair of third heat pipes 36a extends through the plurality of third fins 34′. A third connecting block 38a is attached to the second end of the pair of third heat pipes 36′. A first end of the fourth heat pipe 46a extends through the plurality of third fins 34′. A fourth connecting block 48a is attached to the second end of the fourth heat pipe 46′. The second heat dissipation module 50a utilizes the third heat sink 30a to dissipate heat for multiple heat generating components of the motherboard 14.

The first heat dissipation module 50 or the second heat dissipation module 50a is attached on the base panel 12, rather than being attached on the heat generating components directly, which can save space above the motherboard 14 and reduce a thickness of the electronic device.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. An electronic device comprising:
a mainframe module comprising a base panel and a motherboard attached on the base panel, the motherboard having a first heat generating component and a second heat generating component mounted thereon; and
a heat dissipation module comprising a first heat sink, a second heat sink attached to a first open side of the first heat sink, a first heat pipe, and a second heat pipe; the first heat pipe is connected to and located between the first heat sink and the first heat generating component, and the second heat pipe is connected to and located between the second heat sink and the second heat generating component;
wherein the motherboard and the heat dissipation module are mounted on the base panel side by side.

2. The electronic device of claim 1, wherein the heat dissipation module further comprises at least one fan attached to a second open side of the first heat sink, and the first heat sink is located between the at least one fan and the second heat sink.

3. The electronic device of claim 2, wherein the first heat sink comprises a first outer shell and a plurality of first fins parallel to each other and enclosed by the first outer shell, and the second heat sink comprises a second outer shell and a plurality of second fins parallel to each other and enclosed by the second outer shell.

4. The electronic device of claim 3, wherein an axis of the at least one fan is parallel to each of the plurality of first fins and the plurality of second fins.

5. The electronic device of claim 3, wherein a first end of the first heat pipe extends through the plurality of first fins, and a first connecting block is attached to a second end of the first heat pipe and contacts the first heat generating component; and a first end of the second heat pipe extends through the plurality of second fins, and a second connecting block is attached to a second end of the second heat pipe and contacts the second heat generating component.

6. The electronic device of claim 1, wherein the first heat generating component is a central processing unit, and the second heat generating component is a video card.

7. The electronic device of claim 6, wherein the video card is attached to the motherboard and moveable along a direction that is parallel to the motherboard.

8. An electronic device comprising:
a mainframe module comprising a base panel and a motherboard attached on the base panel, the motherboard having a first heat generating component and a second heat generating component mounted thereon; and
a heat dissipation module comprising at least one fan, a heat sink attached to an airflow outlet of the at least one fan, a first heat pipe, and a second heat pipe; the first heat pipe is connected to and located between the heat sink and the first heat generating component, and the second heat pipe is connected to and located between the heat sink and the second heat generating component;
wherein the motherboard and the heat sink are mounted on the base panel side by side.

9. The electronic device of claim 8, wherein the heat sink comprises an outer shell and a plurality of fins parallel to each other and enclosed by the outer shell.

10. The electronic device of claim 9, wherein an axis of the at least one fan is parallel to each of the plurality of fins.

11. The electronic device of claim 9, wherein a first end of the first heat pipe extends through the plurality of fins, and a connecting block is attached to a second end of the first heat pipe and contacts the first heat generating component; and a first end of the second heat pipe extends through the plurality of fins, and a second connecting block is attached to a second end of the second heat pipe and contacts the second heat generating component.

12. The electronic device of claim 8, wherein the first heat generating component is a central processing unit, and the second heat generating component is a video card.

13. The electronic device of claim 12, wherein the video card is attached to the motherboard and moveable along a direction that is parallel to the motherboard.

14. The electronic device of claim 8, further comprising a power supply module, an optical disk drive, and a hard disk drive attached on the base panel.
